(19) United States
(12) Patent Application Publication
(10) Pub. No.: US 2011/0047885 A1
(43) Pub. Date: Mar. 3, 2011

(54) Window Stop

(76) Inventor: Ping-Yen Chen, Taipei County (TW)

(21) Appl. No.: 12/617,899

(22) Filed: Nov. 13, 2009

(30) Foreign Application Priority Data
Sep. 1, 2009 (TW) 098200296

(51) Int. Cl. E06B 7/00

(52) U.S. Cl. 49/504

(57) ABSTRACT

A window stop includes a housing, a sliding block, a tightening up screw member, two clamping blocks and a cover. Rotating the tightening up screw member causes the sliding block to move the two clamping blocks toward each other, thereby clamping on the rail of a window tightly to have a predetermined gap be kept between the window and the window frame for indoor air circulation and to stop the window from being fully opened, preventing gas poisoning due to stagnant air or falling of a child from the building accidentally and prohibiting intrusion of a thief.

### BACKGROUND OF THE INVENTION

1. Field of the Invention

The present invention relates to window technology and more particularly, to a window stop that can be conveniently affixed to a window rail at a predetermined location so that a predetermined gap will be kept between the window and the window frame, assuring a high level of safety and effectively preventing intrusion of a thief.

2. Description of the Related Art

Taiwan Utility Patent M279707, issued to the present inventor, discloses a window stop, which is capable of holding the window in position so that a predetermined gap will be kept between the window and the window frame, assuring a high level of safety and effectively preventing intrusion of a thief. However, the user must make a mounting hole on the frame of the window for the installation of the window stop. Making such a mounting through hole destroys the sense of beauty of the window. Further, this design of window stop is comprised of a big number of component parts, complicating the installation and increasing the manufacturing cost.

### SUMMARY OF THE INVENTION

The present invention has been accomplished under the circumstances in view. It is therefore the main object of the present invention to provide a window stop, which uses a vertically movable sliding block to control movement of two clamping blocks, so that the clamping blocks can be conveniently controlled to clamp on a window rail firmly, simplifying the operation.

It is another object of the present invention to provide a window stop, which can be installed in a window conveniently without making any mounting hole or destroying the structure of the window.

It is still another object of the present invention to provide a window stop, which can be conveniently adjusted relative to the window to the desired position subject to the gap required between the window and the window frame.

It is still another object of the present invention to provide a window stop, which keeps a gap between the window and the window frame, facilitating indoor air circulation and avoiding a gas poisoning accident.

It is still another object of the present invention to provide a window stop, which stops the window from being fully opened, prohibiting intrusion of a thief.

It is still another object of the present invention to provide a window stop, which stops the window from being fully opened, prohibiting falling of a child from the building accidentally.

To achieve these and other objects of the present invention, a window stop window stop includes a housing, a sliding block, a tightening up screw member, two clamping blocks and a cover. Rotating the tightening up screw member causes the sliding block to move the two clamping blocks toward each other, thereby clamping on the rail of a window tightly to have a predetermined gap be kept between the window and the window frame for indoor air circulation and to stop the window from being fully opened, preventing gas poisoning due to stagnant air or falling of a child from the building accidentally and prohibiting intrusion of a thief.

### BRIEF DESCRIPTION OF THE DRAWING

FIG. 1 is an exploded view of a window stop in accordance with the present invention.

FIG. 2 is an oblique elevation of the window stop in accordance with the present invention.

FIG. 3 corresponds to FIG. 2 when viewed from another angle.

FIG. 4 is an applied view of the present invention, showing the window stop installed in a window rail.

FIG. 5 is a sectional view of the present invention, showing the window stop installed in a window rail.

FIG. 6 is a schematic sectional view of the present invention, showing the coupling arrangement between the respective guide rods of the clamping blocks and the respective sliding grooves of the housing.

FIG. 7 is a schematic sectional view of the present invention, showing the coupling arrangement between the respective guide rods of the clamping blocks and the respective sliding grooves of the cover.

### DETAILED DESCRIPTION OF THE INVENTION

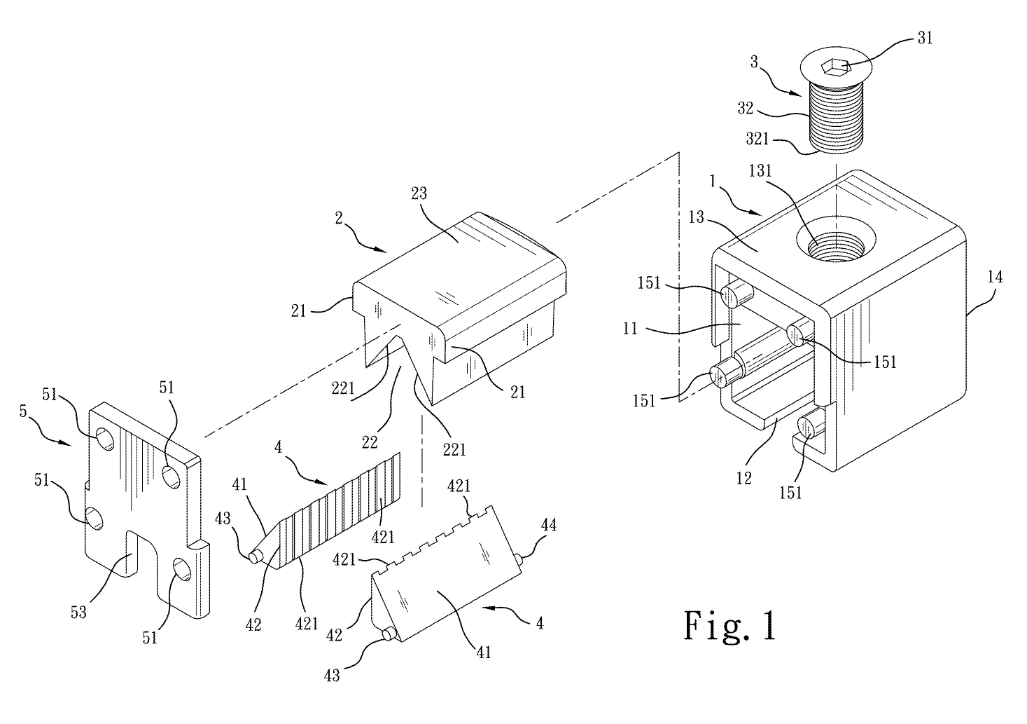

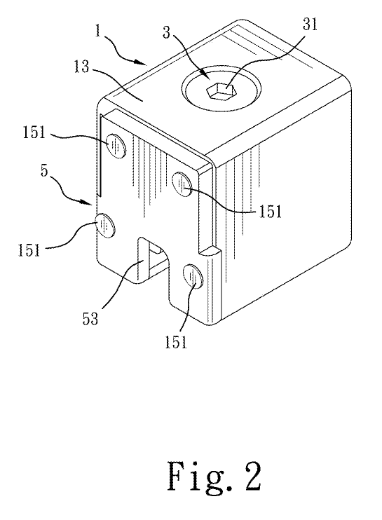

Referring to FIGS. 1-7, a window stop in accordance with the present invention is shown comprising a housing 1, a sliding block 2, a tightening up screw member 3, two clamping blocks 4 and a cover 5.

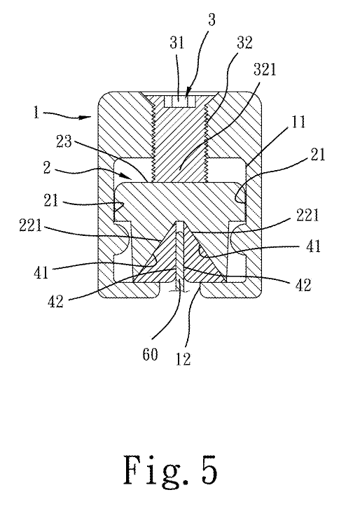

The housing 1 comprises a vertical sliding way 11 defined therein for the sliding of the sliding block 2 vertically, a bottom slot 12 cut through the bottom wall thereof in communication between the vertical sliding way 11 and the outside space, a screw hole 131 located on the top wall 13 in communication with the vertical sliding way 11 (see FIG. 5), a notch 142 located on the bottom side of the front wall 14 thereof corresponding to the bottom slot 12 for coupling to a rail 60 of a window 6, two sliding grooves 141 transversely bilaterally located on the inner side of the front wall 14 and a plurality of rivet rods 151 horizontally disposed at the rear side thereof for holding the cover 5.

The sliding block 2 has two side flanges 21 respectively coupled to and vertically movable along the vertical sliding way 11 of the housing 1, and two beveled bottom faces 221 disposed at the bottom side thereof. The two beveled bottom faces 221 define a triangular bottom opening 22 for receiving the two clamping blocks 4.

The tightening up screw member 3 has a tool groove 31 located on the top side thereof for the positioning of a hand tool, a threaded thank 32 for threading into the screw hole 131 of the housing 1 and a bottom edge 321 for stopping against the top wall 23 of the sliding block 2. Further, the tool groove 31 can be a socket groove, crossed groove, keystone groove or blossom-shaped groove.

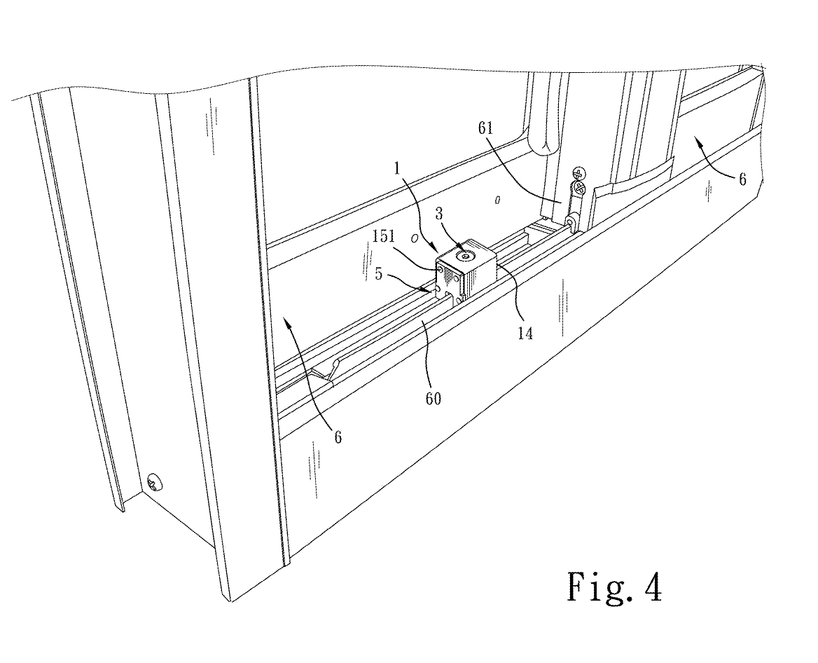

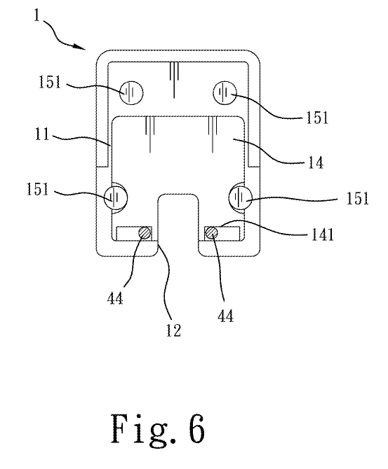

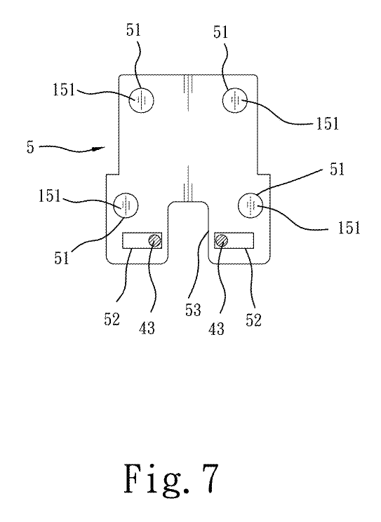

The two clamping blocks 4 are set in the triangular bottom opening 22 of the sliding block 2, each having a beveled contact wall 41 respectively kept in close contact with the two beveled bottom faces 221 of the sliding block 2 and a vertical clamping wall 42 attached to one of the two opposite lateral sides of the rail 60 of the window 6. The clamping wall 42 of each clamping block 4 has a plurality of ribs 421 that enhance friction between the respective clamping block 4 and the rail 60 of the window 6 (see FIG. 4 and FIG. 5). Each clamping block 4 further has a plurality of guide rods 44 and 43 respectively perpendicularly extended from the front and rear sides thereof and respectively coupled to the two sliding grooves 141 of the housing 1 (see FIG. 6) and respective sliding grooves 52 on the cover 5 (see FIG. 7).

The cover 5 has a plurality of mounting holes 51 respectively coupled to the rivet rods 151 of the housing 1, two sliding grooves 52 horizontally bilaterally located on the front side thereof and respectively coupled to the guide rods 43 of the clamping blocks 4 and a bottom notch 53 attached to the rail 60 of the window 6.

After the window stop is attached to the rail 60 of the window 6, a hand tool is attached to the tool groove 31 of the tightening up screw member 3 and operated to rotate the tightening up screw member 3 downwards relative to the housing 1, forcing the bottom edge 321 of the tightening up screw member 3 against the top wall 23 of the sliding block 2, and therefore the sliding block 2 is lowered. At this time, the beveled bottom faces 221 of the sliding block 2 are respectively forced against the beveled contact walls 41 of the clamping blocks 4, moving the two clamping blocks 4 toward each other, and therefore the vertical clamping walls 42 of the two clamping blocks 4 are respectively firmly secured to the two opposite lateral sides of the rail 60 of the window 6 (see FIG. 5). Thus, the front wall 14 of the housing 1 can stop against one side 61 of the window 6 (see FIG. 4) to prevent falling of a child from the building accidentally. Further, another side of the window 6 can be kept spaced from the window frame (not shown) at a distance for indoor air circulation to avoid a gas poisoning accident due to stagnant air.

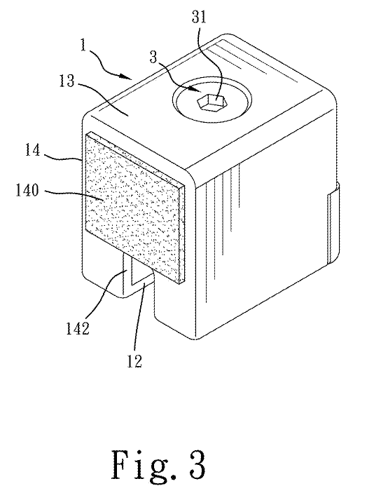

Further, a pad 140 can be fixedly mounted on the front wall 14 of the housing 1 (see FIG. 3) for stopping against one side 61 of the window 6. The pad 140 can be prepared from rubber, silicon rubber or elastic plastics.

In conclusion, the invention provides a window stop, which has the following advantages:
1. By means of rotating the tightening up screw member 3, the sliding block 2 is lowered to move the two clamping blocks 4 toward each other so that the clamping walls 42 of the clamping blocks 4 are firmly clamped on the two opposite lateral sides of the rail 60 of the window 6. This operation procedure is quite simple
2. Mounting of the window stop is quite simple and need not make a hole on the window 6 or destroy the structure of the window 6.
3. After fixation of the window stop to the rail 60, the distance between the side 61 of the window 6 and the window frame is determined, Thus, the user can adjust the position of the window stop on the rail 60 subject to the desired gap between the window and the window frame.
4. After installation of the window stop, a gap is kept between the window and the window frame for indoor air circulation, avoiding gas poisoning due to stagnant air.
5. After installation of the window stop, the window 6 cannot be fully opened, prohibiting intrusion of a thief.
6. After installation of the window stop, the window 6 cannot be fully opened, preventing falling of a child from the building accidentally.

What is claimed is:

1. A window stop, comprising:
a housing, said housing comprising a vertical sliding way defined therein for the sliding of a sliding block vertically, a bottom slot cut through a bottom wall thereof in communication with said vertical sliding way, a screw hole located on a top wall thereof in communication with said vertical sliding way, a notch located on a bottom side of a front wall thereof corresponding to said bottom slot for coupling to a rail of a window and two sliding grooves transversely bilaterally located on an inner side of said front wall;
a sliding block vertically movably mounted inside said housing, said sliding block comprising two side flanges respectively coupled to and vertically movable along said vertical sliding way of said housing and two beveled bottom faces disposed at a bottom side thereof, said two beveled bottom faces defining a triangular bottom opening for receiving two clamping blocks;
a tightening up screw member, said tightening up screw member comprising a tool groove located on the top side thereof for the positioning of a hand tool, a threaded thank for threaded into said screw hole of said housing and a bottom edge stopped against a top wall of said sliding block;
two clamping blocks set in the triangular bottom opening of said sliding block, each said clamping block comprising a beveled contact wall kept in close contact with one of the two beveled bottom faces of said sliding block, a vertical clamping wall attached to one of two opposite lateral sides of the rail of the window, a plurality of guide rods respectively perpendicularly extended from front and rear sides thereof, the guide rods at the front side of each of said clamping blocks being respectively coupled to the two sliding grooves of said housing; and
a cover covered on a rear side of said housing opposite to said front wall of said housing, said cover comprising two sliding grooves horizontally bilaterally located on a front side thereof and respectively coupled to the guide rods at the rear side of said clamping blocks and a bottom notch attached to the rail of the window.

2. The window stop as claimed in claim 1, wherein said housing comprises a flexible pad covered on an outer side of the front wall thereof, said flexible pad being prepared from one of a material group of rubber, silicon rubber and flexible plastics.

3. The window stop as claimed in claim 1, wherein said housing comprises a plurality of rivet rods horizontally disposed at the rear side thereof for holding said cover; said cover comprises a plurality of mounting holes respectively fixedly fastened to the rivet rods of said housing.

4. The window stop as claimed in claim 1, wherein said cover comprises a plurality of mounting holes fixedly fastened to the rear side of said housing with respective fastening members.

5. The window stop as claimed in claim 1, wherein said tool groove is a socket groove, crossed groove, keystone groove or blossom-shaped groove.

6. The window stop as claimed in claim 1, wherein the clamping wall of each said clamping block has a plurality of ribs.
